(19) United States
(12) Patent Application Publication
(10) Pub. No.: US 2016/0329205 A1
(43) Pub. Date: Nov. 10, 2016

(54) Lamp

(71) Applicant: OSRAM GmbH, Munich (DE)

(72) Inventor: Andreas Nittke, Adelschlag (DE)

(21) Appl. No.: 15/145,857

(22) Filed: May 4, 2016

(30) Foreign Application Priority Data
May 5, 2015 (DE) 10 2015 208 246.6

(51) Int. Cl. H01K 1/32

(52) U.S. Cl. CPC H01K 1/325

(57) ABSTRACT

In various embodiments, a lamp is provided. The lamp includes a lamp vessel, and a sleeve which surrounds the lamp vessel. A fastening element is provided for mounting the lamp vessel in the sleeve. The fastening element has two wall sections between which a lamp vessel section is arranged. The wall sections of the fastening element each have at least one aperture.

### CROSS-REFERENCE TO RELATED APPLICATION

This application claims priority to German Patent Application Serial No. 10 2015 208 246.6, which was filed May 5, 2015, and is incorporated herein by reference in its entirety.

### TECHNICAL FIELD

Various embodiments relate generally to a lamp.

### BACKGROUND

A lamp is disclosed, for example, in laid-open specification WO 2010/094580 A1. Said specification describes a lamp having a lamp vessel and a sleeve which is in the form of a reflector and which surrounds the lamp vessel, where a fastening element is provided for mounting the lamp vessel in the reflector, and where the fastening element has two wall sections between which a lamp vessel section is arranged.

### SUMMARY

In various embodiments, a lamp is provided. The lamp includes a lamp vessel, and a sleeve which surrounds the lamp vessel. A fastening element is provided for mounting the lamp vessel in the sleeve. The fastening element has two wall sections between which a lamp vessel section is arranged. The wall sections of the fastening element each have at least one aperture.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a perspective illustration of the lamp according to various embodiments;

FIG. 2 shows a longitudinal section through the lamp depicted in FIG. 1 along a sectional plane which contains the axis A-A of longitudinal extent of the lamp;

FIG. 3 shows a partially sectional side view of the lamp depicted in FIG. 1 and FIG. 2 in a view rotated through an angle of 90° about the axis A-A of longitudinal extent in relation to the illustration in FIG. 2;

FIG. 4 shows a plan view of an end face of the fastening element of the lamp depicted in FIG. 1 to FIG. 3;

FIG. 5 shows a side view of the fastening element depicted in FIG. 4 in a view rotated through an angle of 90° about the longitudinal axis A-A of the lamp in relation to the illustration in FIG. 2;

FIG. 6 shows a plan view of the bottom face of the fastening element depicted in FIG. 4 and FIG. 5; and

FIG. 7 shows a perspective illustration of the fastening element depicted in FIG. 4 to FIG. 6.

### DESCRIPTION

The following detailed description refers to the accompanying drawings that show, by way of illustration, specific details and embodiments in which the invention may be practiced.

Various embodiments provide a lamp which has a fastening element which makes it possible for the lamp to be subjected to a lower level of thermal loading.

A lamp according to various embodiments has a lamp vessel and a sleeve which surrounds the lamp vessel. A fastening element is provided for mounting the lamp vessel in the sleeve. The fastening element has two wall sections between which a lamp vessel section is arranged.

According to various embodiments, the two wall sections of the fastening element each have at least one aperture. This makes it possible for the lamp vessel to be more effectively cooled and for the lamp vessel section which is mounted by the fastening element to be subjected to a lower level of thermal loading.

The lamp vessel section which is arranged between the two wall sections of the fastening element may be an end of the lamp vessel from which power supply lines protrude. As a result, the fastening element of the lamp according to various embodiments does not cause any shadowing since the abovementioned end of the lamp vessel serves to seal off the lamp vessel and supply power to a lighting means which is arranged within the lamp vessel, and does not play any role in light emission.

The two wall sections of the fastening element may run parallel to an axis of longitudinal extent of the lamp. As a result, the insertion depth of the lamp into the sleeve can be defined by means of the dimensions of the abovementioned wall sections in the direction of longitudinal extent.

The fastening element of the lamp according to various embodiments may have a central section which connects the two wall sections, between which a lamp vessel section is arranged, to one another and which has an opening for receiving the lamp vessel section which is arranged between the two wall sections. This makes it possible for the lamp vessel to be mounted in a simple manner.

The fastening element may have at least two spring lugs which are angled away from the edge of the abovementioned opening and bear against the lamp vessel section with a clamping fit. This makes it possible for the fastening element to be mechanically fixed to the lamp vessel section in a simple manner.

The two wall sections of the fastening element between which the lamp vessel section is arranged each may have a flange region which bears against the sleeve. This makes it possible for the fastening element to be fixed to the sleeve. The flange regions can have a coding means for installing the lamp vessel in the sleeve in the correct position.

The fastening element of the lamp according to various embodiments may be composed of sheet metal. As a result, the fastening element can be produced as a stamped and bent part in a simple manner.

According to various embodiments, the sleeve of the lamp according to various embodiments is in the form of a reflector.

The flange regions of the fastening element may bear against an inner face of the reflector, outside a reflection surface of the reflector. To this end, the inner face of the reflector advantageously has at least one projection against which the flange regions bear.

However, as an alternative, the sleeve can also be in the form of a transparent outer bulb.

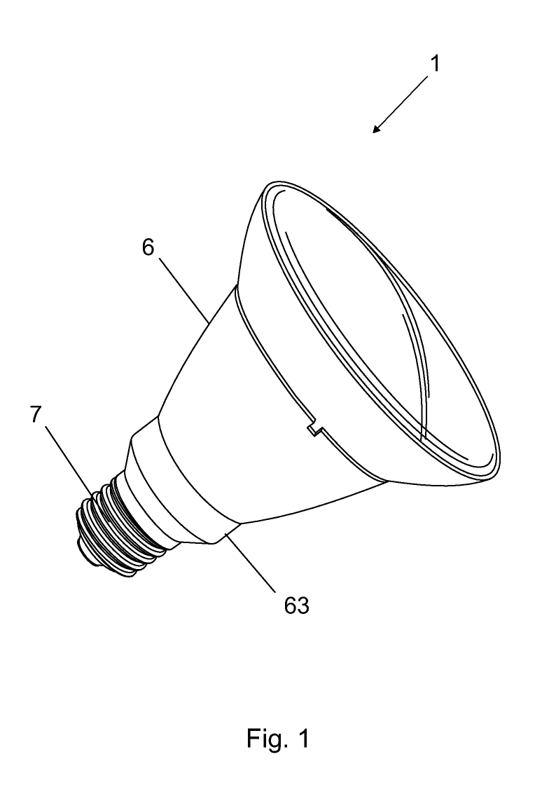

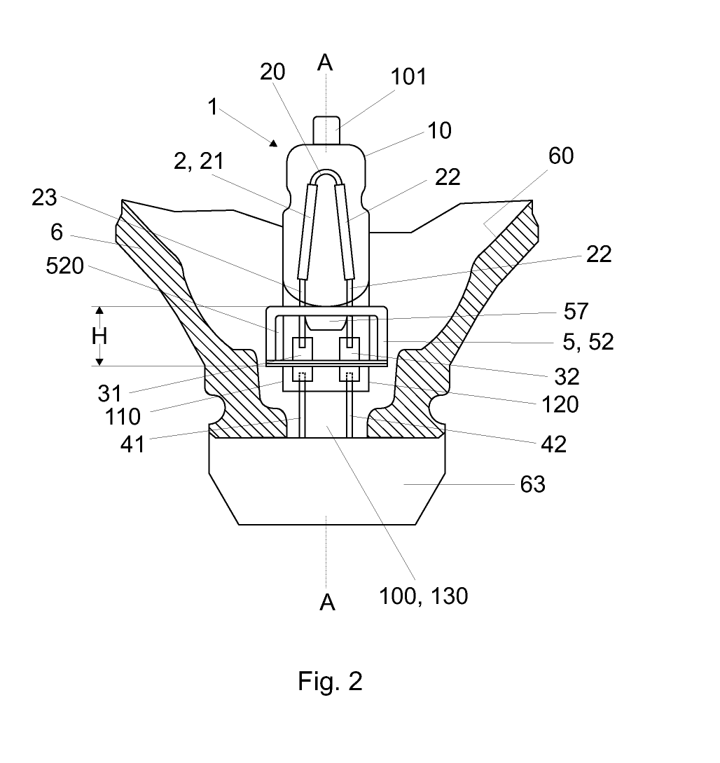

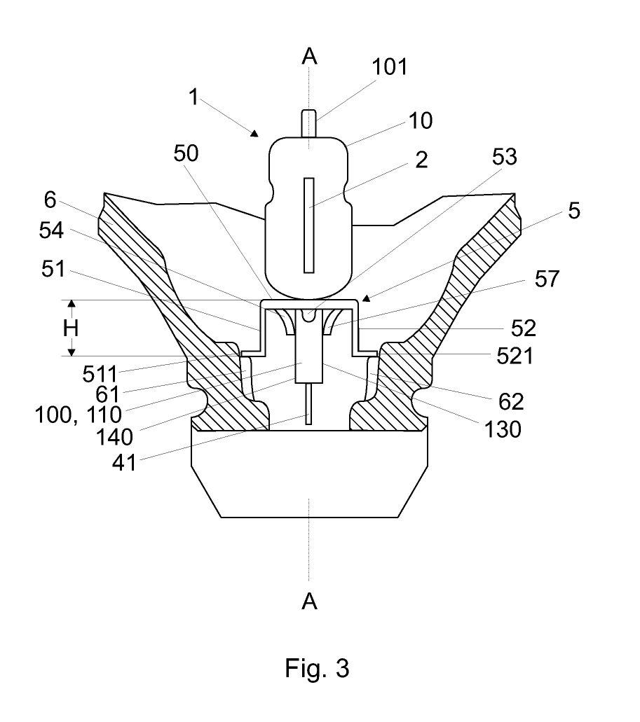

The lamp according to various embodiments which is schematically illustrated in FIG. 1 to FIG. 3 is a reflector lamp 1 which has a substantially parabolic reflector 6 and a screw-type base 7 which is arranged on a base section 63 of the reflector 6.

The lamp 1 is in the form of a halogen incandescent lamp and has a lamp vessel 10 which is composed of quartz glass, a V-shaped incandescent filament 2 which is composed of tungsten wire being enclosed in the interior of said lamp vessel. The incandescent filament 2 has two incandescent filament sections 21, 22 which are illuminated during operation and which are connected to one another by a non-illuminating incandescent filament section 20. The non-illuminating incandescent filament section 20 is mounted between two recesses of the lamp vessel 10. The ends 23, 24 of the incandescent filament 2 are each welded to a molybdenum foil 31, 32 which is embedded in a gas-tight manner in the glass material of a sealed-off end 100 of the lamp vessel 10 and are in the form of power transmission lines. The sealed-off end 100 is in the form of a pinch seal with a substantially rectangular cross section and has two narrow sides 110, 120 which are situated opposite one another and also two broad sides 130, 140 which are situated opposite one another. The molybdenum foils 31, 32 are each connected to a power supply wire 41 or 42 which protrudes from the sealed-off end 100 of the lamp vessel 10. The power supply wires 41, 42 which protrude from the lamp vessel 10 and the molybdenum foils 31, 32 serve to supply power to the incandescent filament 2. A cup of the lamp vessel 10, which cup is situated diametrically opposite the sealed-off end 100, is sealed off by means of a molten exhaust tube 101.

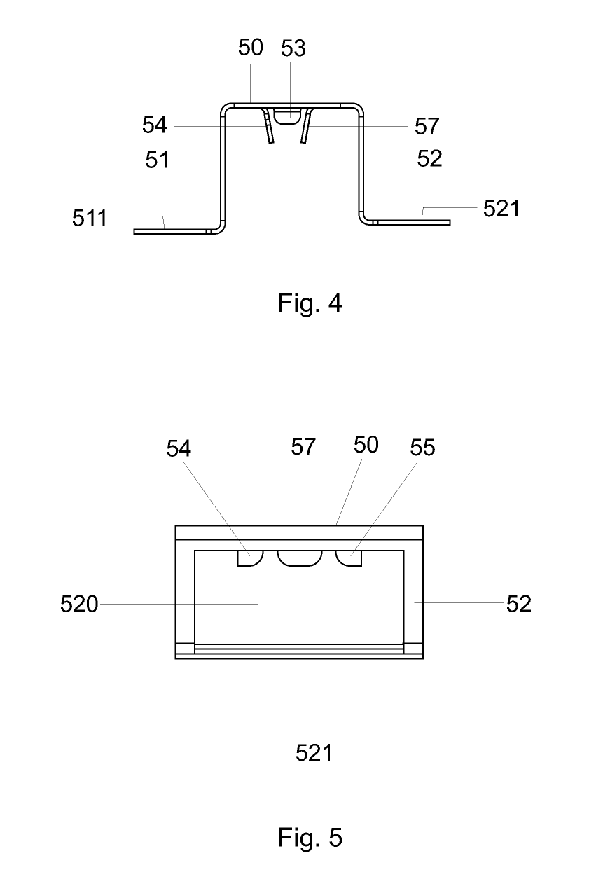

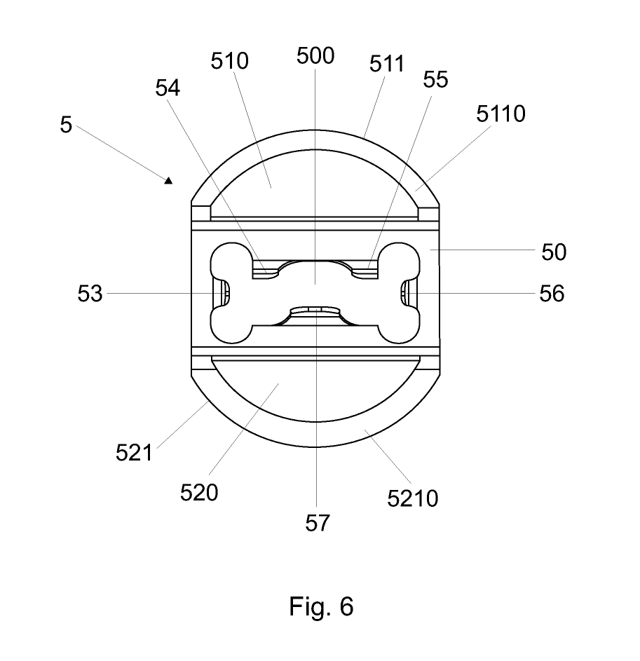

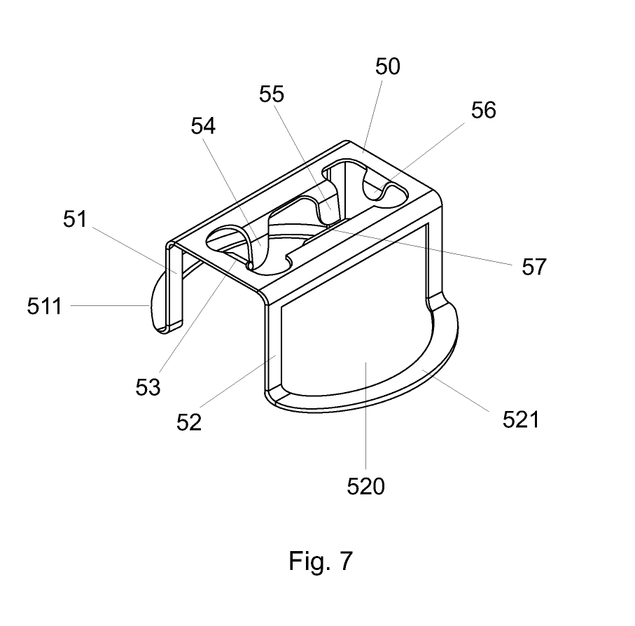

The sealed-off end 100 of the lamp vessel 10 is fixed in a reflector 6 with the aid of a fastening means 5. The fastening means 5 is in the form of a fixing ring. Details of the fixing ring 5 are illustrated in FIG. 4 to FIG. 7.

The fixing ring 5 is composed of a steel sheet and is designed as a stamped and bent part. FIG. 4 shows a plan view of an end face of the fixing ring 5. The fixing ring 5 has two wall sections 51, 52 which run parallel to one another, which are connected to one another by a central section 50 of the fixing ring 5 and which are each angled away from the central section 50 at a right angle. The wall sections 51, 52 which run parallel to one another each have a flange region 511, 521 which is in the form of a segment of a ring and which respectively forms a support surface 5110, 5210 which is oriented parallel to the central section 50 and therefore perpendicular to the wall sections 51, 52. The support surfaces 5110, 5210 of the two flange regions 511, 521 lie in the same plane. The wall sections 51, 52 which run parallel to one another are each provided with an aperture 510, 520 which extends into the flange region 511 or 521 of the respective wall section 51 or 52. The two wall sections 51, 52 which run parallel to one another run parallel to the axis A-A of longitudinal extent of the lamp. Said wall sections 51, 52 have the same dimensions and their dimension parallel to the axis A-A of longitudinal extent corresponds to a physical height H of the fixing ring 5. The physical height H of the fixing ring 5 determines the installation depth of the lamp vessel 10 in the reflector 6.

The central section 50 of the fixing ring 5 is equipped with an opening 500 for receiving the sealed-off end 100 of the lamp vessel 10. The sealed-off end 100 of the lamp vessel 10 is arranged between the two wall sections 51, 52 of the fixing ring 5. A total of five spring lugs 53, 54, 55, 56, 57 which are angled away from the edge and which serve to fix the sealed-off end 100 of the lamp vessel 10 in the opening 500 of the fixing ring 5 are integrally formed on the edge of the opening 500. Two spring lugs 53, 56 which are situated opposite one another are designed in such a way that they bear against the narrow sides 110, 120 of the sealed-off end 100 of the lamp vessel 10 with a clamping fit. The three other spring lugs 54, 55, 57 are designed in such a way that they bear against the broad sides 130, 140 of the sealed-off end 100 of the lamp vessel 10 with a clamping fit. The sealed-off end 100 of the lamp vessel 10 is mounted in the opening 500 of the fixing ring 5 with a clamping fit by means of the five spring lugs 53, 54, 55, 56, 57. The apertures 510, 520 in the two wall sections 51, 52, between which the sealed-off end 100 of the lamp vessel 10 is arranged, reduce the thermal loading on the sealed-off end 100 of the lamp vessel 10 in the region of the molybdenum foils 31, 32. As a result, it may be possible to dispense with, for example, chrome-plating or other finishing of the surfaces of the molybdenum foils 31, 32.

The support surfaces 5110, 5210 of the flange regions 511, 521 of the two wall sections 51, 52 of the fixing ring 5 which run parallel to one another each bear against a projection 61 or 62 on the inner face of the reflector 6. The projections 61, 62 are located outside the substantially parabolic reflection surface 60 of the reflector 6 on its inner face.

The reflector 6 has a base section 63 which is provided with a screw-type base 7. The two power supply wires 41, 42 are each connected to an electrical contact of the screw-type base 7.

The invention is not restricted to the embodiments explained in detail above. By way of example, the lamp can also have a glass outer bulb instead of the reflector 6, and the fixing ring 5 can serve to fasten the lamp vessel 10 in the outer bulb.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A lamp, comprising:
a lamp vessel; and
a sleeve which surrounds the lamp vessel;
wherein a fastening element is provided for mounting the lamp vessel in the sleeve; and
wherein the fastening element has two wall sections between which a lamp vessel section is arranged;
wherein the wall sections of the fastening element each have at least one aperture.

2. The lamp of claim 1,
wherein the lamp vessel section is a sealed-off end of the lamp vessel from which power supply lines protrude.

3. The lamp of claim 1,
wherein the two wall sections of the fastening element run parallel to an axis of longitudinal extent of the lamp.

4. The lamp of claim 1,
wherein the fastening element has a central section which connects the two wall sections to one another and which has an opening for receiving the lamp vessel section which is arranged between the two wall sections.

5. The lamp of claim 4,
wherein the fastening element has at least two spring lugs which are angled away from the edge of the opening and bear against the lamp vessel section with a clamping fit.

6. The lamp of claim 1,
wherein the two wall sections of the fastening element each have a flange region which bears against the sleeve.

7. The lamp of claim 1,
wherein the fastening element is composed of sheet metal.

8. The lamp of claim 1,
wherein the sleeve is in the form of a reflector.

9. The lamp of claim 8,
wherein the flange regions of the fastening element bear against an inner face of the reflector, outside a reflection surface of the reflector.
